(19) United States
(12) Patent Application Publication
(10) Pub. No.: US 2023/0027898 A1
(43) Pub. Date: Jan. 26, 2023

(54) VEHICLE FLOOR AND CORRESPONDING PRODUCTION METHOD

(71) Applicant: AUTOTECH ENGINEERING, S.L., Amorebieta Etxano (ES)

(72) Inventors: Sergi MARQUEZ DURAN, Rajadell Barcelona (ES); Jordi HERRANZ TOMAS, Sant Boi de Llobregat (ES); Guillermo LINARES CAYERO, Rubí (ES)

(21) Appl. No.: 17/774,622

(22) PCT Filed: Nov. 11, 2020
(86) PCT No.: PCT/EP2020/081809

§ 371 Date: May 5, 2022

(30) Foreign Application Priority Data
Nov. 12, 2019 (EP) 19382991.8

(51) Int. Cl. B62D 25/20; B62D 29/00; B21D 53/88; B21D 35/00

(52) U.S. Cl. CPC B62D 25/20; B62D 29/007; B21D 53/88; B21D 35/007

(57) ABSTRACT

A hot stamping vehicle floor (1) for a vehicle frame (100) includes a main floor panel (2) stamped out from at least one sheet metal blank. The floor further includes at least one sheet metal reinforcing patch (4), arranged on the main floor panel (2), overlapping the main floor panel (2). The reinforcing patch (4) is more ductile than the main floor panel (2). The at least one reinforcing patch (4) is joined to at least one area (6) of the main floor panel (2) conceived to withstand compressive crash forces in case of a crash situation of the vehicle and the main floor panel (2) and the at least one reinforcing patch (4) are joined to each other before said vehicle floor (1) is stamped out. The invention also refers to a method for producing the vehicle floor.

### CROSS-REFERENCE TO RELATED APPLICATION

This application is a National Stage application of International Patent Application No. PCT/EP2020/081809, filed on Nov. 11, 2020, which claims priority to European Application No. 19382991.8, filed Nov. 12, 2019, each of which is hereby incorporated by reference in its entirety.

### TECHNICAL FIELD

The invention relates to a hot stamping vehicle floor for a vehicle frame comprising a main floor panel stamped out from a sheet metal.

The invention further relates to a method for producing a hot stamping vehicle floor for a vehicle frame comprising the step of hot stamping at least one sheet metal blank for stamping out a main floor panel.

### BACKGROUND

Vehicle floors for vehicle frames comprise a plurality of different stamping sheet metal components and reinforcements that need to be joint together in order to obtain the final vehicle floor. This implies a very intensive welding assembly work. Welding is known to be a challenging manufacturing process in order to absorb the risk of dimensional distortions due to the local heating. Additionally, special supporting tooling is required in order to join the parts together.

Furthermore, after the floor is completely assembled it must be supplied to the frame mounting line in order to assemble it to the vehicle frame. The floor ready assembled is a heavy and bulky component which is difficult to handle from a logistic point of view.

On the other hand, the different floor components can be produced by different hot or cold forming methods, such as cold stamping, hot stamping (also known as press hardening), roll forming or indirect hot stamping (also known as indirect press hardening).

Among the different techniques, hot stamping is an especially desired method because it allows obtaining parts with a very high yield strength, comprised between 1,200 MPa and 2,000 MPa. However, these parts cannot be used in areas of the vehicle floor conceived to withstand compressive crash forces in case of a crash situation. Although these parts are very hard at the same time, they are fragile. Therefore, in case of a crash situation this stiffness can cause the part to suffer undesired mechanical cracks avoiding it to fulfill its safety function. Due to this, the floor must be tailored from a plurality of single parts with different mechanical characteristics to the specific deformation needs of each area thereof. Consequently, a dedicated tooling and dies are required for every single part. Also, a very relevant welding cost is required.

Additionally, with the expansion of hybrid and electric vehicles it is more and more often required that vehicle frames, such as for example, car frames, offer as much space as possible in the floor area, in order for it to accommodate the batteries of the vehicle.

Batteries are very heavy and bulky components that due to their weight need to be accommodated in the vehicle frame in the lowest possible position in order to hinder the vehicle dynamics as less as possible. Normally batteries are shaped in the shape of a parallelepipedic box with a very long and wide base. They also extend mainly in the longitudinal vehicle direction and have a reduced height in order to let free space for the vehicle's inner compartment. The position of the batteries causes the traditional vehicle floors geometry to be completely redesigned in order to fulfill both the security cell function, as well as the battery accommodation function.

DE202010017552U1 discloses a body structure, in particular floor structure, for a motor vehicle, with structural components defining load paths for crash situations. In the area of the structural components that are placed in at least one defined load path, in particular a front crash load path and/or a side crash load path and/or a rear crash load path, the components are formed at least in part by high-strength structural components, preferably by completely hardened or at least partially hardened high-strength structural components, from a hot-stamping or cold-stamping steel sheet, which are directly or indirectly, preferably directly, connected to one another, are solidly connected to one another, in particular via a force and/or shape and/or material connection.

US2014147693A1 discloses a formed member which can be manufactured at a low cost, which has excellent dimensional accuracy, which has excellent axial crushing properties and three-point bending properties, which has excellent bending stiffness and torsional stiffness, and which is suitable for use in a component of a motor vehicle. The formed member has a reinforcing member which is joined by a welding on a ridge portion. It is manufactured by joining a flat sheet-metal blank and a flat sheet-metal reinforcing member by welding and performing bending so that the welding becomes a ridge portion.

### SUMMARY

It is an object of the invention to propose a hot stamping vehicle floor fora vehicle frame which is easier to produce and that is lighter than the vehicle floors of the state of the art. This purpose is achieved by a hot stamping vehicle floor of the type indicated at the beginning, characterized in that it further comprises at least one sheet metal reinforcing patch, arranged on said main floor panel overlapping said main floor panel, said at least one reinforcing patch being more ductile than said main floor panel, said at least one reinforcing patch being joined to at least one area of said main floor panel, said at least one area being conceived to withstand compressive crash forces in case of a crash situation of said vehicle and said main floor panel and said at least one reinforcing patch being joined to each other before said vehicle floor is stamped out.

The steel for use in a press-hardening process is a boron steel called 22MnB5. This kind of steel is normally coated with a AlSi layer in order to improve its corrosion resistance. This kind of steel can be hardened if it is firstly heated up to a temperature of about 900° C., which provides for an austenite microstructure formation, and then it is rapidly cooled down (known as quenching step), thus obtaining a martensite microstructure.

A second type of press hardening steel is the multistep press hardening steel. This type of steel is also a boron steel, but it has a slightly different composition with respect to the conventional one described before. This type of boron steel is called 22MnB8. This kind of steel is normally coated with a layer of zinc, which have a better behaviour against corrosion than AlSi. For obtaining a hard microstructure, the steel is heated up to a temperature of austenitization (about 900° C.), and the steel can be cooled down at a very low cooling rate (room-temperature-air cooling rate), thus obtaining a martensite microstructure.

Non-hardenable steel can be subjected to a press hardening process, but its hardness is not increased as the result of the press hardening step.

As it is well known by the skilled person, the term “ductility” refers to the measure of the material's ability to undergo a plastic deformation before breaking. The ductility is more commonly expressed as percent elongation or percent area reduction from a standard tensile test according to the following ISO norm: ISO 6892-1:2016 Metallic materials—tensile testing. Method of test at room temperature.

The preferred way for calculating the ductility is based on the percentage elongation of a metal probe during the tensile test, as follows:

% Elongation=(L_{f}−L₀)/L₀

L₀ being the initial probe length, while L_{f} is the probe length before breaking.

Alternatively, it can be measured according to the area reduction.

% Area reduction=(A₀−A_{f})/A₀

A₀ being the initial probe cross section, while A_{f} is the probe cross section before breaking.

Additionally, in the invention the expression “conceived to withstand compressive crash forces in case of a crash situation of said vehicle” refer to those vehicle areas in which the vehicle frame is designed to withstand the compressive forces in case of a crash basing on the design experience or know how of the skilled person. However, it can happen that, eventually, depending on the direction of the crash that these areas must withstand other type of efforts.

Finally, when the sheet metal reinforcing patch is arranged on the main floor panel, overlapping the main floor panel, in this area the thickness of the assembly is the addition of the thickness of the main floor panel and the reinforcing patch.

Back to the solution proposed by the invention, once the part is readily hot-stamped, the reinforcing patch completely covers the overlapping area with the main floor panel such as to increase the vehicle floor thickness in the amount of the patch thickness.

The combination of overlapping soft and hard materials in the areas conceived to withstand compressive crash forces in case of a crash situation the fully hardened material obtained by hot stamping can increase the bending angle. Now, these areas withstand more deformation without rupture risk and makes the vehicle obtained by hot stamping material suitable for safety applications.

Additionally, the vehicle floor according to the invention dramatically reduces the number of parts required to obtain the final vehicle floor. This leads to a manufacturing simplification and costs reduction, because less parts need to be separately formed and lately joined together by welding. Furthermore, the possibility of using more hot-stamping sheet metal blanks, the thickness of the parts can also be reduced and together with the amount of single part reduction, a relevant weight reduction can be achieved.

A hot stamping process according to the invention comprises any hot stamping process such as direct or indirect hot stamping, also known as press hardening or indirect press hardening, as well as a multistep hot stamping or press hardening process.

The conventional press hardening process is as follows:
a) the sheet metal blank starts the process at room temperature,
b) the blank is then heated in a furnace up to about 900° C. for obtaining an austenite microstructure,
c) then the blank is introduced and formed in the pressing die into the desired part shape and held in the die closed position for several second, thus allowing the blank to rapidly cool down,
d) this cooling down causes the austenite to transform into martensite thus obtaining a much harder part,
   Eventually some additional operations after the cooling down, can be required.

The indirect press hardening process is as follows:
a) the sheet metal blank starts the process at room temperature,
b) the blank is preformed into a cold stamping die and formed into the desired pre-shaped part,
c) the pre-shaped part is then heated in a furnace up to about 900° C. for obtaining an austenite microstructure,
d) then the part is introduced and formed in the pressing die and held in the die closed position for several second, thus allowing the blank to rapidly cool down,
e) this cooling down causes the austenite to transform into martensite, providing the final hardness to the part.

Finally, a multistep press hardening requires the use of special press hardening steels. Some steel manufacturers have developed steels that can be hardened without having to be cooled rapidly. This type of steels are sometimes called air-hardenable steels. Their microstructure can be transformed from austenite to martensite) without a rapid cooling process.

In the case of multistep press hardening process, the process takes places as follows:
a) the sheet metal blank starts the process at room temperature,
b) the blank is then heated in a furnace up to about 900° C. for obtaining an austenite microstructure,
c) then the blank is introduced and formed in a multistep pressing die into the desired part shape, in which different forming steps take place, as the part is move forward within the die. The blank is first cooled down to about 500° C., then formed, and then post-processed as required,
d) in this case there is no need of rapid cooling. The finished part is cooled down at room temperature.

The invention further includes a number of preferred features that are object of the dependent claims and the utility of which will be highlighted hereinafter in the detailed description of an embodiment of the invention.

Preferably said main floor panel is made from a press hardening steel also known as hot-formed steel, while the reinforcing patch is made from non-hardenable steel.

In a preferred embodiment seeking to stiffen the vehicle floor said main floor panel comprises at least one reinforcing beam directly stamped out from said sheet metal blank and in that said at least one reinforcing patch is arranged and joined to said at least one reinforcing beam of said vehicle floor.

In another preferred embodiment seeking for an increase of the bending angle of the areas conceived to withstand compressive crash forces in a crash situation, said at least one reinforcing patch is between 10% and 80% more ductile than said main floor panel preferably between 25% and 70%.

In order to simplify the vehicle floor production and its conformability said main floor panel and said reinforcing patch have a thickness between 0.5 and 8 mm, preferably between 0.5 and 6 mm, more preferably between 0.5 and 3 mm and especially preferably between 0.8 and 1.5 mm.

Also, in a preferred embodiment in order to reduce the logistic costs, said main floor panel and said reinforcing patch have the same thickness. This avoids the need of handling with many different blank thicknesses.

Preferably, in order to avoid premature corrosion of the vehicle frame said main floor panel and said reinforcing patch are zinc coated.

In order to provide an improved side crash behaviour, in a preferred embodiment said vehicle floor defines a longitudinal direction corresponding to the driving direction and a perpendicular direction and said at least one reinforcing patch extends in said perpendicular direction.

In the particular case of a car frame, the frame has normally three pillars known as A, B and C. In 5 door vehicles the B pillar is conceived to hinge the door giving access to the second sit rows. Precisely this central area of the car is the less rigid of the car frame. The vehicle frame, and more particularly the vehicle floor, comprises also seat cross members that, a part from function of providing anchoring points to the seat structure, also collaborate in the stiffening of the vehicle frame and the safety cell thereof. Therefore, in order to improve the safety cell function of the vehicle frame, the at least one reinforcing patch of the vehicle floor overlaps the position of the seat cross members of the main floor panel.

In order to reduce the manufacturing complexity, said main floor panel is made from one single sheet metal blank. In this way, the complete floor can be produced in one single hot stamping step notably reducing or minimizing the need of post-welding steps.

In another embodiment said main floor panel and said at least one reinforcing patch are joined together by one or more methods of the group consisting of resistance spot welding, standard laser welding, remote laser welding, resistance seam welding (RSEW), gas metal arc welding and laser and arc hybrid welding.

Also, in order to obtain an optimum degree of ductility of the areas conceived to withstand compression forces under crash situations, said main floor panel has a tensile strength between 1,400 MPa and 2,000 MPa, and said at least one sheet metal reinforcing patch has a tensile strength between 500 and 1,000 MPa.

The invention, further relates to a method for producing a hot stamping vehicle floor for a vehicle frame with which the floor is easier to be produced and that the resulting floor is lighter than the vehicle floors of the state of the art.

The invention solves this problem with a method as described above, characterized in that before said hot stamping step, the method further comprises the steps of arranging at least one reinforcing patch onto said sheet metal blank, overlapping said sheet metal blank in at least one area of said vehicle floor conceived to withstand compressive crash forces in case of a crash situation, joining said at least one reinforcing patch and said sheet metal blank.

As it will be further explained below, the method according to the invention provides for a much simpler vehicle floor, with much less parts and a remarkable weight reduction.

In a preferred embodiment said joining step is carried out by one or more methods of the group consisting of resistance spot welding, standard laser welding, remote laser welding, resistance seam welding (RSEW), gas metal arc welding and laser and arc hybrid welding.

In the method according to the invention it is also preferable that the main floor panel is made from a press hardening steel and said reinforcing patch is made from non-hardenable steel.

Likewise, the invention also includes other features of detail illustrated in the detailed description of an embodiment of the invention and in the accompanying figures.

### BRIEF DESCRIPTION OF THE DRAWINGS

Further advantages and features of the invention will become apparent from the following description, in which, without any limiting character, preferred embodiments of the invention are disclosed, with reference to the accompanying drawings in which:

FIG. 1, a perspective view of a vehicle floor according to the state of the art.

FIG. 2, a perspective view of a vehicle floor according to the invention.

FIG. 3, a side view of the vehicle floor of FIG. 2.

FIG. 4, a top plan view of the vehicle floor of FIG. 2 showing the reinforcing patches arranged on the reinforcing beams.

FIG. 5, a vehicle frame including the floor according to the invention.

FIG. 6, a detail view of the vehicle frame of FIG. 5 in case of a side crash situation.

FIG. 7 a numerical simulation of the area shown in FIG. 6 of the vehicle floor of FIG. 2 in the crash situation.

FIG. 8, a detail view of a vehicle floor according to the invention, in which the floor panel and the reinforcing patches are spot welded.

FIG. 9, a detail view of a vehicle floor according to the invention, in which the floor panel and the reinforcing patches are laser welded.

FIG. 10, a diagrammatical representation of a first embodiment of the method according to the invention.

### DETAILED DESCRIPTION

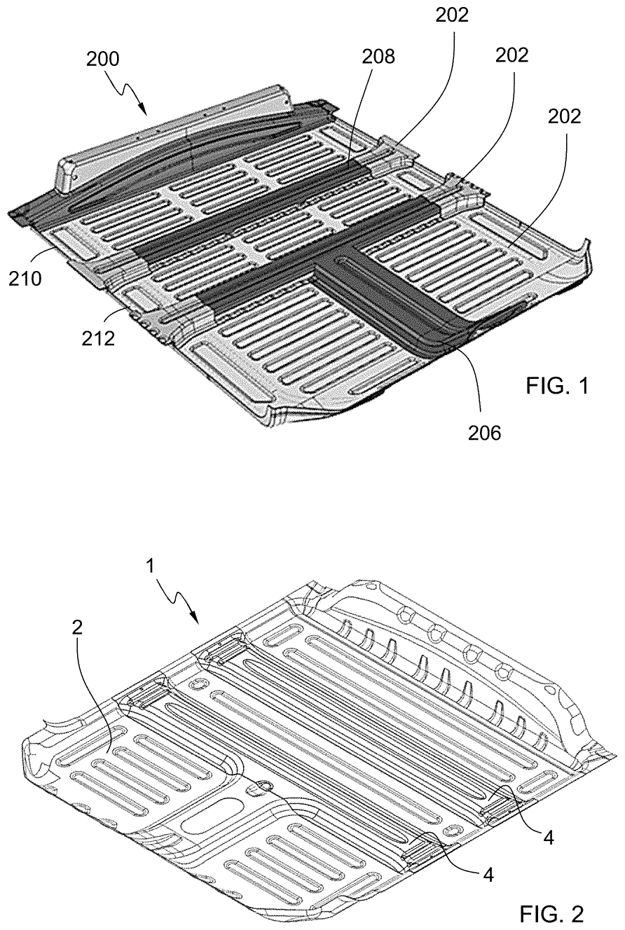

FIG. 1 shows a vehicle floor 200 of the state of the art. This vehicle floor of the state of the art comprises a plurality of sheet metal parts, including front panels 202, cross beams 204, longitudinal beams 206, beam reinforcements 208, rear panels 210, middle panel 212 and others. This vehicle floor 200 is made up from 16 independent stamping sheet metal parts in total. These 16 parts must be formed independently and later must be correspondingly joined by any suitable welding process, such spot welding, laser welding or the like. Once finished, the vehicle floor 30 has a weight of more than 30 kg.

In order to solve the problem of proposing a hot stamping vehicle floor for a vehicle frame which is easier to produce and that is lighter than the vehicle floors of the state of the art, the invention foresees as a hot stamping vehicle floor 1 for a vehicle frame 100 comprising a main floor panel 2 stamped out from at least one sheet metal blank of 1 mm thickness, but is especially preferred that it is made from one single sheet metal blank. Preferably said main floor panel 2 is made from a hot-formed steel.

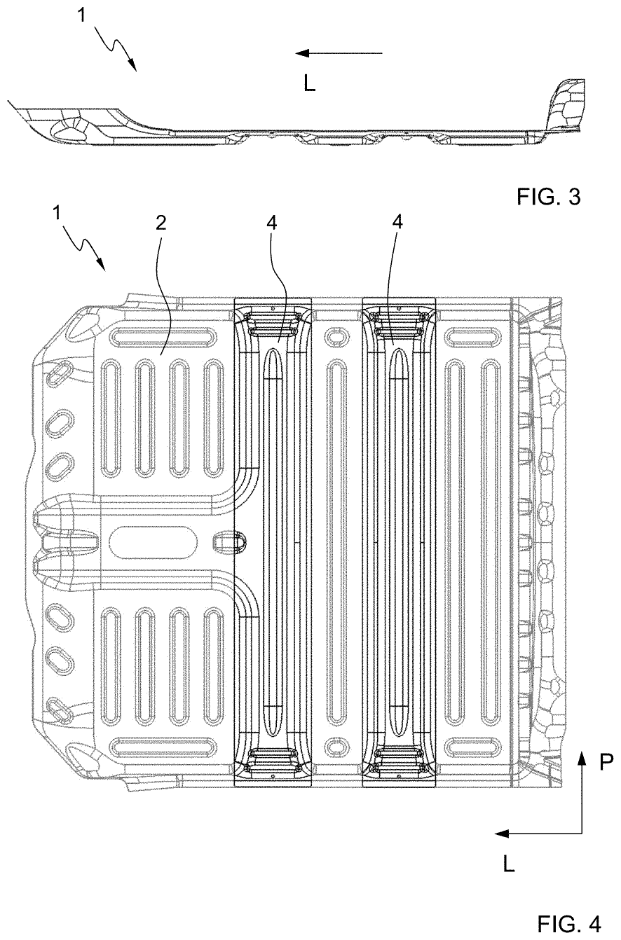

As it is apparent from FIGS. 3 and 4 said vehicle floor 1 defines a longitudinal direction L corresponding to the driving direction and a perpendicular direction P and in that said at least one reinforcing patch extends in said perpendicular direction P.

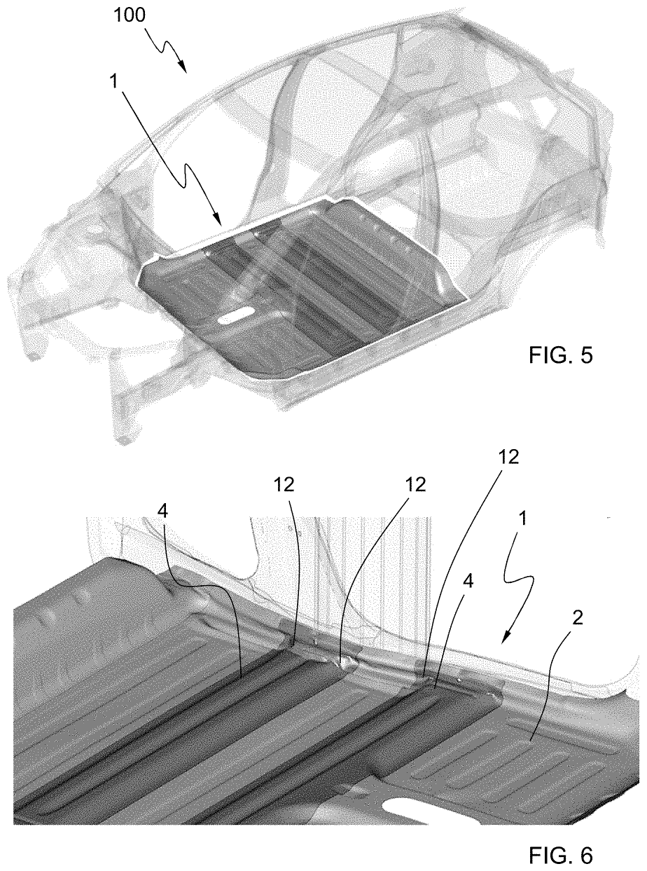

In the floor of FIGS. 2 to 7, in order to solve the problem of the invention, the vehicle floor 2, further comprises two sheet metal reinforcing patches 4, arranged on the main floor panel 2 overlapping the main floor panel 2. Preferably. reinforcing patches 4 are made from a hot-formed sheet steel of 1 mm of thickness.

The two reinforcing patches 4 more ductile than the main floor panel 2. In particular, the reinforcing patches 4 are between 10% and 80% more ductile than the main floor panel 2 and preferably between 25% and 70%. The main floor panel 2 has a tensile strength between 1,400 MPa and 2,000 MPa, and the sheet metal reinforcing patch 4 has a tensile strength between 500 and 1,000 MPa.

Materials fulfilling such conditions are, for example hot-formed grades. The floor panel 2 can be made of a steel for hot stamping, such as the Usibor® 2000 or 1500 of the company Arcelor Mittal, while the reinforcement patches 4 can be made of a steel for hot stamping such as the Ductibor® 450, 500 or 1000 of the same company indicated before.

It is especially preferable that both the main floor panel 2 and the reinforcing patches 4 are zinc coated.

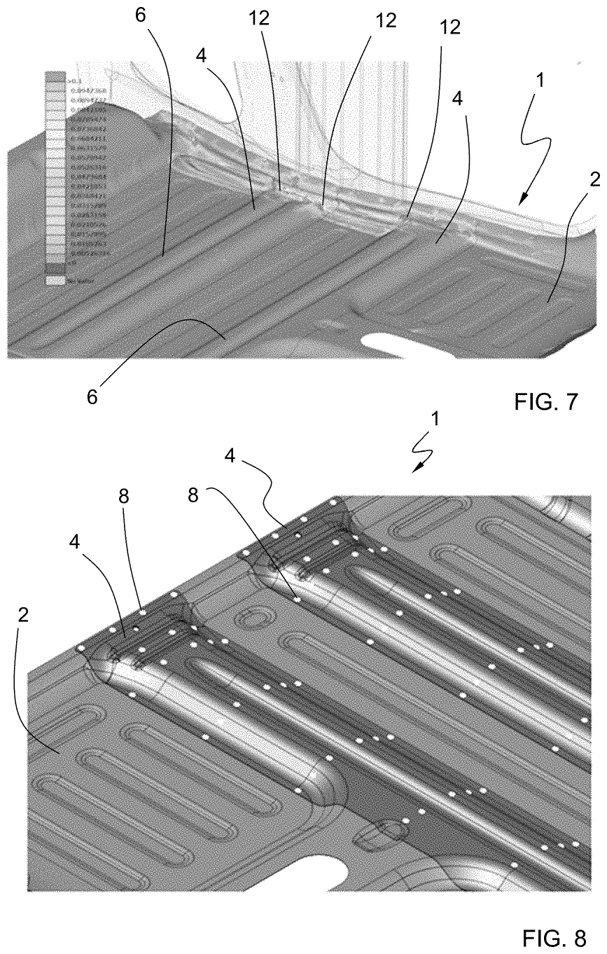

The reinforcing patches 4 are joined to two areas 6 of the main floor panel 2 conceived to withstand compressive crash forces in case of a crash situation of the vehicle. In this case, the areas 6 of overlapping concerned correspond to the cross members 12 on to which the seats are attached. From FIG. 7, it is apparent that in this case the whole cross member of the main floor panel 2 is covered with a reinforcing patch 4 due to constructive requirements. However, when a side crash situation takes place, the points affected with the highest compression peaks are the side edges 12 of the vehicle floor which are subject to the highest deformation.

Both the main floor panel 2 and the two reinforcing patches 4 are joined to each other before the vehicle floor 1 is stamped out by any suitable welding technique such as one or more methods of the group consisting of resistance spot welding, standard laser welding, remote laser welding, resistance seam welding (RSEW), gas metal arc welding and laser and arc hybrid welding.

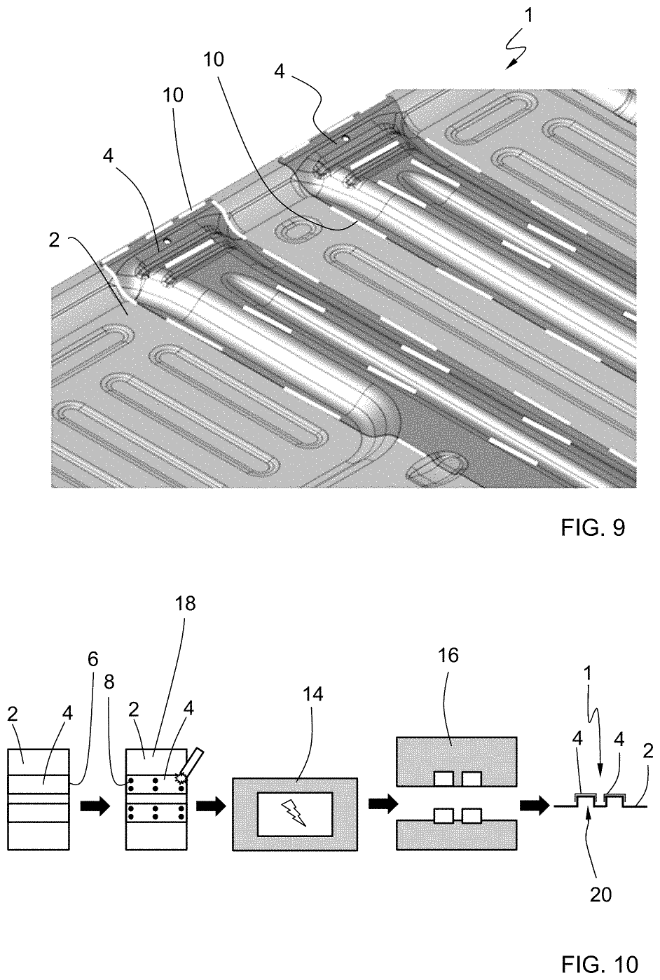

FIG. 8 shows the embodiment in which the floor panel 2 and the reinforcing patches 4 are spot welded before being stamped out with a plurality of welding spots 8. Instead, in the embodiment of FIG. 9, the floor panel 2 and the reinforcing patches 4 are joined by way of laser seams 10 obtained by laser welding.

Also, as already explained the main floor panel 2 comprises two reinforcing beams for the seat attachment directly stamped out from the sheet metal blank corresponding to the cross members for attaching the vehicle seats. The reinforcing patches 4 are arranged and joined to the reinforcing cross beams of the vehicle floor 1.

Therefore, once the main floor panel 2 and the reinforcement patches 4 are joined a hot stamping step takes place for forming the vehicle floor 1. In other words, in one simple hot-stamping stroke the vehicle floor 1 can be produced.

Comparatively to the vehicle floor of FIG. 1, the embodiment shown in FIGS. 2 to 5, comprises only 3 parts, and one single forming tool, compared to the 16 parts individually produced of the floor of the state of the art.

For example, thanks to this design already described, about a 20% of the weight is reduced in comparison to the floor of FIG. 1. However, even higher weight reductions are achievable depending on the floor design. Additionally, although the parts reduction, the vehicle floor withstands satisfactorily crash situations as the one shown in FIGS. 6 and 7.

Finally, FIG. 10 shows an embodiment of the method according to the invention.

Firstly, from left to right in FIG. 10, a sheet metal blank of hot stamping steel is provided for forming the main floor panel 2. Two reinforcing patches 4 of non-hardenable steel are arranged onto the sheet metal blank, overlapping the sheet metal blank in the areas 6 of the vehicle floor 1 conceived to withstand compressive crash forces in case of a crash situation.

Next, these two reinforcing patches 4 are welded together. In this embodiment, the welding is carried out by spot welding, but as already explained, other welding methods are also possible.

Once the three blanks are joined together to form one single final blanc 18, they are introduced in the furnace 14 and they are heated up to about 900° C.

Finally, the heated final blanc 18 is introduced in the press hardening die for hot stamping the sheet metal final blank 18 for stamping out the main floor panel 2. At the right side of the FIG. 10 it is apparent the overlapping of the two reinforcing patches 4 with the main floor panel 2 in the cross beam area 20.

The one-piece floor assembly provides for weight, parts, and welding reduction. The only problem in a conventional fully hardened solution is the high risk of rupture of the fully martensitic material in crash tests. However, this risk is minimized by the addition of the ductile material patches that improve performance and avoids cracks of the fully hardened main floor panel 2.

While the present disclosure has been illustrated and described with respect to a particular embodiment thereof, it should be appreciated by those of ordinary skill in the art that various modifications to this disclosure may be made without departing from the spirit and scope of the present disclosure.

1. A hot stamping vehicle floor (1) for a vehicle frame (100) comprising:
[a] a main floor panel (2) stamped out from at least one sheet metal blank, characterized in that
[b] said main floor panel (2) is made from one single sheet metal blank, the vehicle floor (1) further comprising
[c] at least one sheet metal reinforcing patch (4), arranged on said main floor panel (2), overlapping said main floor panel (2),
[d] said at least one reinforcing patch (4) being more ductile than said main floor panel (2),
[e] said at least one reinforcing patch (4) being joined to at least one area (6) of said main floor panel (2), said at least one area (6) being conceived to withstand compressive crash forces in case of a crash situation of said vehicle and
[f] said main floor panel (2) and said at least one reinforcing patch (4) being joined to each other before said vehicle floor (1) is stamped out.

2. The vehicle floor (1) of claim 1, characterized in that said main floor panel (2) is made from a press hardening steel and said reinforcing patch (4) is made from non-hardenable steel.

3. The vehicle floor (1) according to claim 1 or 2, characterized in that said main floor panel (2) comprises at least one reinforcing beam directly stamped out from said sheet metal blank and in that said at least one reinforcing patch (4) is arranged and joined to said at least one reinforcing beam of said vehicle floor (1).

4. The vehicle floor (1) according to any of claims 1 to 3, characterized in that said at least one reinforcing patch (4) is between 10% and 80% more ductile than said main floor panel (2) and preferably between 25% and 70%.

5. The vehicle floor (1) according to any of claims 1 to 4, characterized in that said main floor panel (2) and said reinforcing patch (4) have a thickness between 0.5 and 8 mm, preferably between 0.5 and 6 mm, more preferably between 0.5 and 3 mm and especially preferably between 0.8 a 1.5 mm.

6. The vehicle floor (1) according to claim 5, characterized in that said main floor panel (2) and said reinforcing patch (4) have the same thickness.

7. The vehicle floor (1) according to any of claims 1 to 6, characterized in that said main floor panel (2) and said reinforcing patch (4) are zinc coated.

8. The vehicle floor (1) according to any of claims 1 to 7, characterized in that said vehicle floor (1) defines a longitudinal direction (L) corresponding to the driving direction and a perpendicular direction (P) and in that said at least one reinforcing patch extends in said perpendicular direction (P).

9. The vehicle floor (1) according to any of claims 1 to 8, characterized in that said main floor panel (2) and said at least one reinforcing patch (4) are joined together by one or more methods of the group consisting of resistance spot welding, standard laser welding, remote laser welding, resistance seam welding (RSEW), gas metal arc welding and laser and arc hybrid welding.

10. The vehicle floor (1) according to any of claims 1 to 9, characterized in that said at least one sheet metal blank for producing said main floor panel (2) has a tensile strength between 1,400 MPa and 2,000 MPa, and said at least one sheet metal reinforcing patch (4) has a tensile strength between 500 and 1,000 MPa.

11. A method for producing a hot stamping vehicle floor (1) for a vehicle frame (100) comprising the step of:
[a] hot stamping at least one sheet metal blank for stamping out a main floor panel (2), characterized in that
[b] said main floor panel (2) is made from one single sheet metal blank, and in that before said hot stamping step, the method further comprises the steps of:
[c] arranging at least one reinforcing patch (4) onto said sheet metal blank, overlapping said sheet metal blank in at least one area (6) of said vehicle floor (1) conceived to withstand compressive crash forces in case of a crash situation, said at least one reinforcing patch (4) being more ductile than said main floor panel (2),
[d] joining said at least one reinforcing patch (4) and said sheet metal blank.

12. The method according to claim 11, characterized in that said joining step is carried out by one or more methods of the group consisting of resistance spot welding, standard laser welding, remote laser welding, resistance seam welding (RSEW), gas metal arc welding and laser and arc hybrid welding.

13. The method according to claim 11 or 12, characterized in that said main floor panel (2) is made from a press hardening steel and said reinforcing patch (4) is made from non-hardenable steel.
